(19) United States
(12) Patent Application Publication
(10) Pub. No.: US 2018/0315072 A1
(43) Pub. Date: Nov. 1, 2018

(54) METHOD AND SYSTEM OF FACILITATING MANAGEMENT OF CRYPTOCURRENCY BASED LOYALTY POINTS ASSOCIATED WITH ONE OR MORE OF A PRODUCT AND A SERVICE

(71) Applicant: Greg Rubin, Calabasas, CA (US)

(72) Inventor: Greg Rubin, Calabasas, CA (US)

(21) Appl. No.: 15/968,505

(22) Filed: May 1, 2018

Related U.S. Application Data
(60) Provisional application No. 62/492,836, filed on May 1, 2017.

(51) Int. Cl. G06Q 30/02; G06Q 20/36; H04L 9/06

(52) U.S. Cl. CPC G06Q 30/0232; G06Q 2220/00; H04L 9/0637; G06Q 20/3678

(57) ABSTRACT

Disclosed is a method of facilitating the issuance, redemption, and management of cryptocurrency-based loyalty points associated with one or more of a product and a service is disclosed. The method may include receiving, using a communication device, a purchase request for obtaining at least one cryptocurrency-based loyalty token to be associated with a user account. Further, the method may include transferring, using the processing device, the at least one cryptocurrency-based loyalty token to a loyalty user wallet associated with the user account based on the purchase request. Further, the method may include storing, using a storage device, token allocation data on a blockchain. Further, the token allocation data may include at least one characteristic associated with each of the user account, the purchase request, transferring of the at least one cryptocurrency-based loyalty token and the loyalty user wallet.

### FIELD OF THE INVENTION

The present invention relates generally relates to the field of data processing. More specifically, the present invention relates to managing of cryptocurrency-based loyalty points associated with products and services.

### BACKGROUND OF THE INVENTION

Individuals are able to travel more economically with an increase in the number of offers, such as reward points, loyalty points, and airline miles provided by hotels, and airlines.

Many airlines offer frequent-flyer loyalty programs to encourage customers to accumulate “miles” which airline customers can redeem to purchase air travel or other rewards.

Further, many hotel chains offer reward points, and loyalty points to encourage customers to stay at the particular hotel chains multiple times.

There are also many other ways to earn points. For example, credit card issuers may partner with airlines and hotels, and award loyalty points or miles based on customer's credit card usage. Points can be redeemed for air travel, ticket upgrades, booking hotels, car rentals, magazine subscriptions and so on.

However, points, or miles earned though those programs are based on complex rules, like class of fare, distance, season or the amount paid.

Further, frequent-flyer program points, and loyalty points may be called as a type of virtual currency in essence. But unfortunately, gaining reward points, frequent flyer miles, and so on is generally a one-way process. Individuals can purchase points with national currencies but are not able to exchange such points back into those currencies.

Further, when individuals actually try to book a flight, they may encounter major hurdles, like blackout dates (days when award seats are limited or unavailable).

Every airline program and hotel chain may have a different set of policies, procedures, restrictions, etc.

In addition, airlines, hotel chains and credit card issuers known to constantly change rules and policies without prior notice. For instance, airlines may increase a minimum number of miles needed to book some flights, or travel points/miles can expire and airline will not honor the ticket redemption. As such, individuals face major issues.

Therefore, there is a need for improved methods and system for managing of cryptocurrency-based loyalty points associated with products and services that may overcome one or more of the abovementioned problems and/or limitations.

### SUMMARY

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

In some embodiments, a method of facilitating issuance and management of cryptocurrency-based loyalty points associated with one or more of a product and a service is disclosed. The method may include receiving, using a communication device, a purchase request for obtaining at least one cryptocurrency-based loyalty token to be associated with a user account. Further, the method may include transferring, using the processing device, the at least one cryptocurrency-based loyalty token to a loyalty user wallet associated with the user account based on the purchase request. Further, the method may include storing, using a storage device, token allocation data on a private or public blockchain. Further, the token allocation data may include at least one characteristic associated with each of the user account, the purchase request, transferring of the at least one cryptocurrency-based loyalty token and the loyalty user wallet.

According to some embodiments, a system of facilitating management of cryptocurrency-based loyalty points associated with one or more of a product and a service is also disclosed. The system may include a communication device configured for receiving a purchase request for obtaining at least one cryptocurrency-based loyalty token to be associated with a user account. Further, the system may include a processing device configured for transferring the at least one cryptocurrency-based loyalty token to a loyalty user wallet associated with the user account based on the purchase request. Further, the system may include a storage device configured for storing token allocation data on a blockchain. Further, the token allocation data may include at least one characteristic associated with each of the user account, the purchase request, transferring of the at least one cryptocurrency-based loyalty token and the loyalty user wallet.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings may contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a platform consistent with various embodiments of the present disclosure.

FIG. 2 is a block diagram of a system of facilitating management of cryptocurrency-based loyalty points associated with one or more of a product and a service, in accordance with some embodiments

FIG. 3 is a flowchart of a method of facilitating management of cryptocurrency-based loyalty points associated with one or more of a product and a service, in accordance with some embodiments.

FIG. 4 is a flowchart of a method of generating cryptocurrency-based loyalty points associated with one or more of a product and a service, in accordance with some embodiments.

FIG. 5 is a flowchart of a method of consuming cryptocurrency-based loyalty points, in accordance with some embodiments.

FIG. 6 is a block diagram, showing the system of facilitating management of cryptocurrency-based loyalty points associated with one or more of a product and a service, interfacing with user devices and external servers, in accordance with an exemplary embodiment.

FIG. 7 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of facilitation of management of cryptocurrency-based loyalty points associated with one or more of a product and a service, in accordance with some embodiments, embodiments of the present disclosure are not limited to use only in this context.

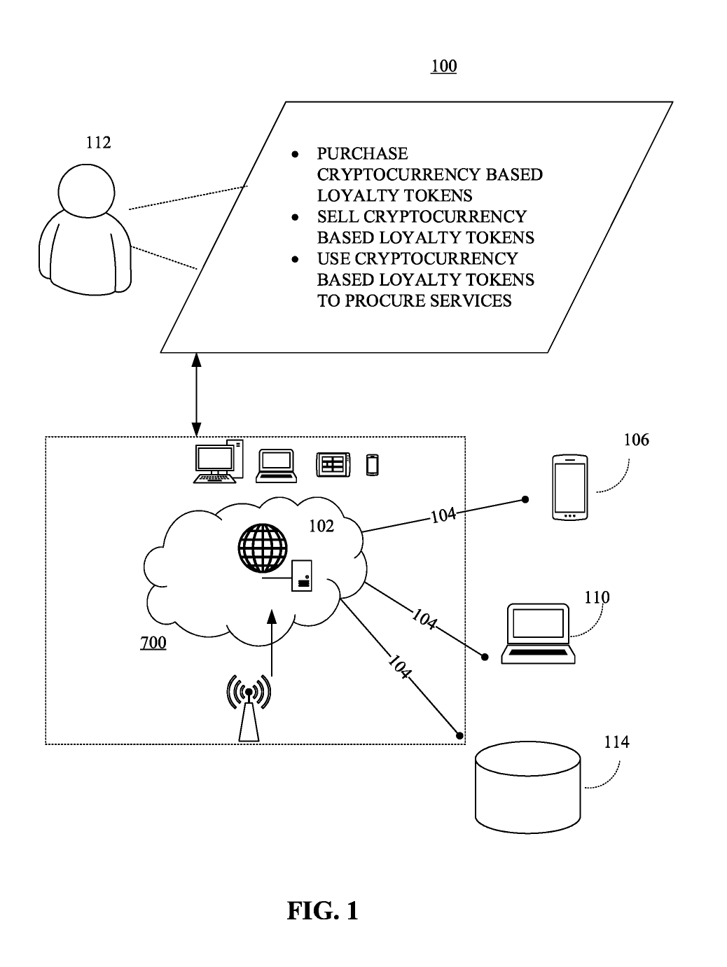

FIG. 1 is an illustration of a platform consistent with various embodiments of the present disclosure. By way of non-limiting example, the online platform 100 for managing a social value of one or more social user accounts may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), and databases 114 (e.g. other online platforms), over a communication network 104, such as, but not limited to, the Internet. Further, users of the platform may include relevant parties such as one or more of travelers, frequent fliers, etc. Accordingly, electronic devices operated by the one or more relevant parties may be in communication with the platform. For example, the mobile device 106 may be operated by a traveler, who may acquire cryptocurrency-based loyalty points and exchange the cryptocurrency-based loyalty points for one or more flight tickets to a destination where the traveler may wish to travel.

A user 112, such as the one or more relevant parties, may access platform 100 through a web-based software application or browser. The web-based software application may be embodied as, for example, but not be limited to, a website, a web application, a desktop application, and a mobile application compatible with a computing device 700.

According to some embodiments, the online platform 100 may communicate with a system to facilitate management of cryptocurrency-based loyalty points associated with one or more of a product and a service, in accordance with some embodiments.

Accordingly, the online platform 100 may be configured to communicate with one or more user devices, such as, but not limited to, smartphones, computer tablets, and computing devices such as personal computers or laptops. Further, the one or more user devices may include wearable devices, such as smartwatches.

The online platform 100 may facilitate generation of one or more cryptocurrency-based loyalty tokens. The one or more cryptocurrency-based loyalty tokens may represent one or more loyalty-based points, such as those offered by one or more hotel chains, airlines, or one or more such establishments offering one or more services, which may be exchanged to procure one or more services offered by the one or more hotel chains, airlines, or one or more such establishments.

The online platform 100 may utilize the infrastructure of blockchain technologies and existing blockchain peer to peer networks such as Bitcoin® blockchain, Ethereum® blockchain, and so on to generate loyalty-based cryptocurrency tokens using smart contracts, such as using ERC 20®.

In an embodiment, a user of the online platform 100 may procure one or more cryptocurrency-based loyalty tokens from a cryptocurrency exchange and may redeem the one or more cryptocurrency-based loyalty tokens with an issuer for a specific service, such as an airline ticket. An issuer may be an entity, or an establishment, that may award one or more users with loyalty points and/or reward points, to be used to procure one or more services from the issuer. The issuer may issue, send, and manage cryptocurrency-based loyalty tokens into a designated customer wallet and may get an approval after a specific number of confirmations from one or more nodes associated with the blockchain peer to peer network. Alternatively, the online platform 100 may be used to generate unique cryptocurrency-based loyalty tokens. Additionally, the online platform 100 to act as an independent third-party broker or issuer for cryptocurrency-based loyalty tokens. As a result, the online platform can be used as an exchange where users can trade and redeem cryptocurrency-based loyalty tokens. Further, the online platform 100 is able to assign unique token codes to generated cryptocurrency-based loyalty tokens. For example, the online platform or issuer may assign a specific airline related and recognizable trading code to a newly created cryptocurrency-based loyalty token. Preferably, the trading code is a five-character alphanumeric code. Users will then be able to exchange the cryptocurrency-based loyalty tokens for airline tickets or other travel related rewards on the specific airline through designated travel agencies or organizations.

Further, the one or more cryptocurrency-based loyalty tokens may also be used to acquire one or more services according to supply and demand and rules and regulations associated with an issuer.

Further, a user may be able to perform transactions associated with the one or more cryptocurrency-based loyalty tokens such as selling the cryptocurrency-based loyalty tokens on one or more cryptocurrency exchanges, and to one or more retailers as payment for goods and services.

Further, if the one or more cryptocurrency-based loyalty tokens achieve a recognized market value, the cryptocurrency-based loyalty tokens may be used in commerce by one or more users, such as by loading or downloading cryptocurrency-based loyalty tokens onto credit cards.

Further, in an embodiment, the online platform 100 may analyze one or more transactions made by one or more users using the cryptocurrency-based loyalty tokens and make one or more recommendations. For instance, if a user makes use of cryptocurrency-based loyalty tokens, and regularly makes travel arrangements to a particular destination, such as a city, the recommendations made to the user may include recommendations about one or more hotels in the city, or one or more airlines providing service to the city, and offering a discount.

Further, in an instance, if the user wishes to make travel arrangements to a particular destination, the user may be recommended times to make the travel arrangements, and one or more airlines, or hotels to make the travel arrangements with, such as one or more hotels, or airlines offering a discount, or one or more hotels that may offer services in a preferred price range of the user (as determined from one or more previous expenditures made by the user).

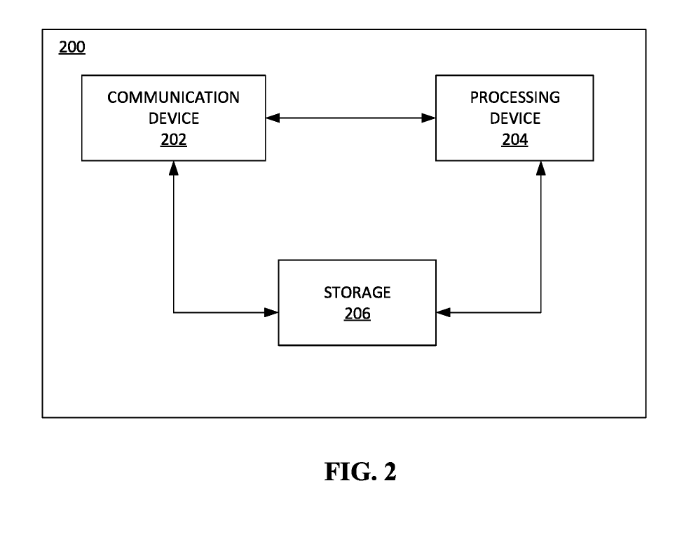

FIG. 2 is a block diagram of a system 200 of facilitating management of cryptocurrency-based loyalty points associated with one or more of a product and a service, in accordance with some embodiments. The system 200 may include a communication device 202 configured for receiving a purchase request for obtaining at least one cryptocurrency-based loyalty token to be associated with a user account.

In some embodiments, the purchase request may include indication of at least cryptocurrency to be exchanged with the at least one cryptocurrency based loyalty token, the method further including transferring, using the processing device 204, at least one cryptocurrency from at least one cryptocurrency wallet associated with the user account to a cryptocurrency program wallet based on an exchange rate between the at least one cryptocurrency and the at least one cryptocurrency based loyalty token.

Further, the system 200 may include a processing device 204 configured for transferring the at least one cryptocurrency-based loyalty token to a loyalty user wallet associated with the user account based on the purchase request.

Further, the system 200 may include a storage device 206 configured for storing token allocation data on a blockchain. Further, the token allocation data may include at least one characteristic associated with each of the user account, the purchase request, transferring of the at least one cryptocurrency-based loyalty token and the loyalty user wallet.

In some embodiments, the communication device 202 may be further configured for receiving a creation request from a user device associated with an issuer account. Further, the creation request may include indication of one or more of the product and the service and at least one rule.

Further, the processing device 204 may be configured for generating a plurality of cryptocurrency-based loyalty tokens based on the creation request. Further, the plurality of cryptocurrency-based loyalty tokens may include the at least one cryptocurrency-based loyalty token.

In some embodiments, the generating may include mining the at least one cryptocurrency-based loyalty token on a cryptocurrency network.

In some embodiments, the generating may include retrieving the plurality of cryptocurrency-based loyalty tokens from a loyalty program wallet.

In some embodiments, the at least one cryptocurrency-based loyalty token corresponds to a plurality of travel points. Further, the plurality of travel points may be used to avail one or more of a travel related product and a travel related service.

In some embodiments, the at least one cryptocurrency-based loyalty token may be traded at a cryptocurrency-based exchange.

Further, the storage device 206 may be configured for storing token creation data including at least one characteristic associated with each of the issuer account, the creation request, the indication of one or more of the product and the service and the plurality of cryptocurrency-based loyalty tokens.

In some embodiments, the communication device 202 may be further configured for: receiving, a redemption request from a point of sale (POS) device. Further, the redemption request may be associated with the user account; and transmitting, using the communication device 202, indication of a consuming of cryptocurrency-based loyalty token to the POS device. Further, a cost of availing one or more of the product and the service may be adjusted according to the cryptocurrency-based loyalty token. Further, the processing device 204 may be configured for performing the consuming of the cryptocurrency-based loyalty token from the loyalty user wallet based on the redemption request.

In some embodiments, the consuming may include destroying, using the processing device 204, the cryptocurrency-based loyalty token.

In some embodiments, the consuming may include transferring, using the processing device 204, the cryptocurrency-based loyalty token to the loyalty program wallet.

Further, the storage device 206 may be configured for storing token redemption data on the blockchain. Further, the token redemption data may include at least one characteristic associated with each of the user account, the redemption request, the consuming of the cryptocurrency-based loyalty token, one or more of the product and the service and the cost.

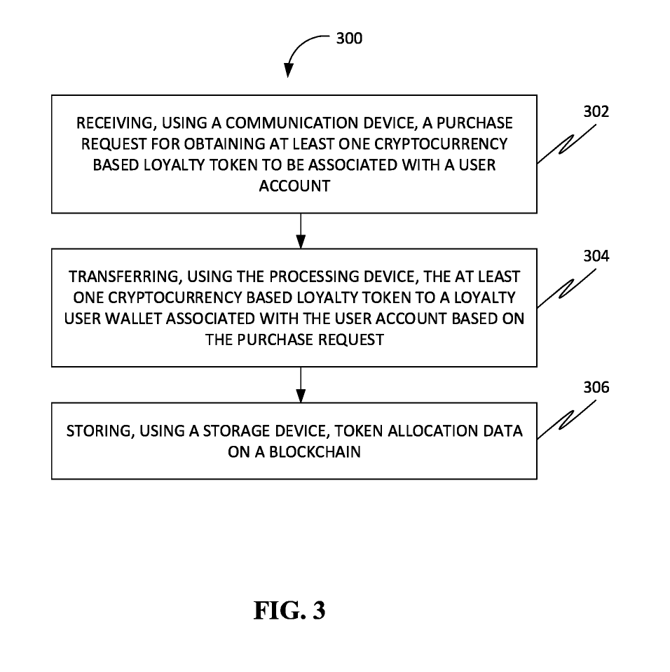

FIG. 3 is a flowchart of a method 300 of facilitating management of cryptocurrency-based loyalty points associated with one or more of a product and a service, in accordance with some embodiments.

At 302, the method 300 may include receiving, using a communication device (such as the communication device 202), a purchase request for obtaining at least one cryptocurrency-based loyalty token to be associated with a user account.

In some embodiments, the purchase request may include indication of at least one cryptocurrency to be exchanged with the at least one cryptocurrency based loyalty token, the method further including transferring, using the processing device, at least one cryptocurrency from at least one cryptocurrency wallet associated with the user account to a cryptocurrency program wallet based on an exchange rate between the at least one cryptocurrency and the at least one cryptocurrency based loyalty token.

In some embodiments, the at least one cryptocurrency-based loyalty token corresponds to a plurality of travel points. Further, the plurality of travel points may be used to avail one or more of a travel related product and a travel related service. In some embodiments, the plurality of travel points may include at least one of a plurality of airline miles and a plurality of hotel points

In some embodiments, the at least one cryptocurrency-based loyalty token may be traded at a cryptocurrency-based exchange.

At 304, the method 300 may include transferring, using a processing device (such as the processing device 204), the at least one cryptocurrency-based loyalty token to a loyalty user wallet associated with the user account based on the purchase request.

At 306, the method 300 may include storing, using a storage device (such as the storage device 206), token allocation data on a blockchain. Further, the token allocation data may include at least one characteristic associated with each of the user account, the purchase request, transferring of the at least one cryptocurrency-based loyalty token and the loyalty user wallet.

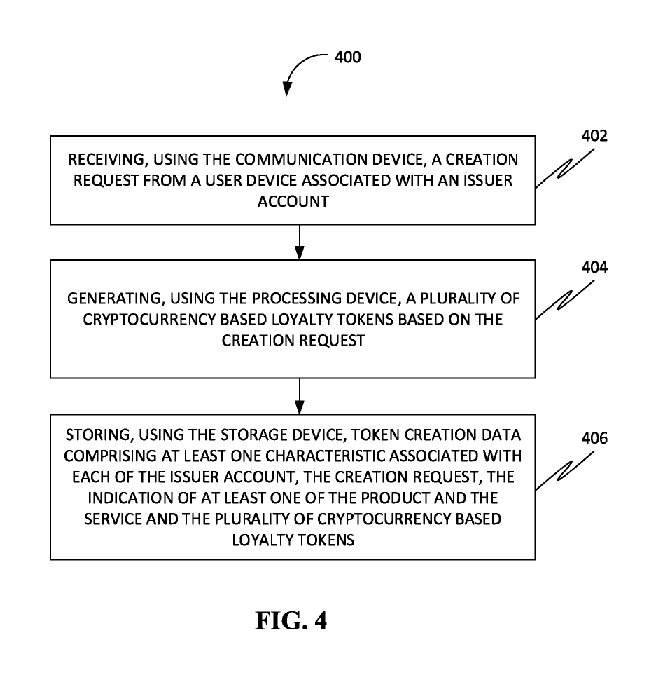

FIG. 4 is a flowchart of a method 400 of generating cryptocurrency-based loyalty points associated with one or more of a product and a service, in accordance with some embodiments.

At 402, the method 400 may include receiving, using the communication device, a creation request from a user device associated with an issuer account. Further, the creation request may include indication of one or more of the product and the service and at least one rule.

At 404, the method 400 may include generating, using the processing device, a plurality of cryptocurrency-based loyalty tokens based on the creation request. Further, the plurality of cryptocurrency-based loyalty tokens may include the at least one cryptocurrency-based loyalty token.

In some embodiments, the generating may include mining the at least one cryptocurrency-based loyalty token on a cryptocurrency network.

In some embodiments, the generating may include retrieving the plurality of cryptocurrency-based loyalty tokens from a loyalty program wallet.

At 406, the method 400 may include storing, using the storage device, token creation data including at least one characteristic associated with each of the issuer account, the creation request, the indication of one or more of the product and the service and the plurality of cryptocurrency-based loyalty tokens.

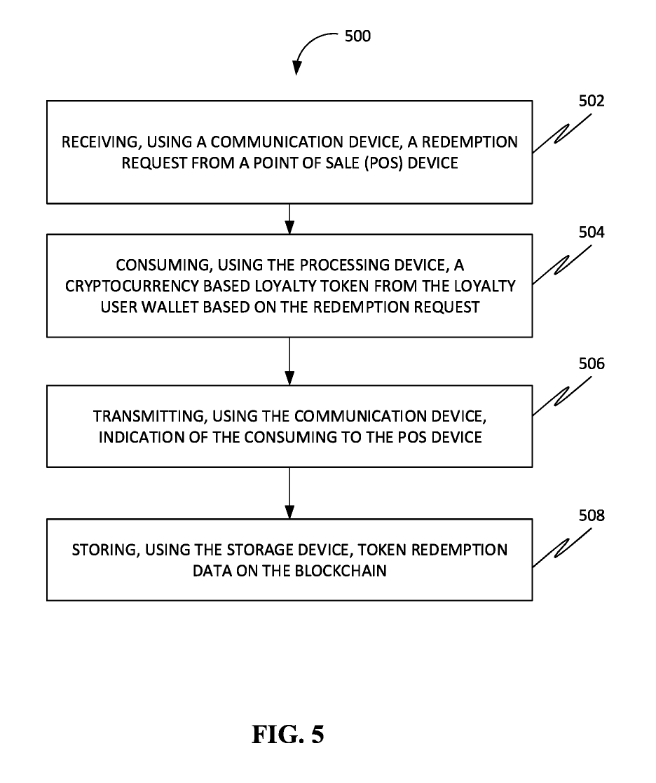

FIG. 5 is a flowchart of a method 500 of consuming cryptocurrency-based loyalty points, in accordance with some embodiments.

At 502, the method 500 may include receiving, using a communication device, a redemption request from a point of sale (POS) device. Further, the redemption request may be associated with the user account.

At 504, the method 500 may include consuming, using the processing device, a cryptocurrency-based loyalty token from the loyalty user wallet based on the redemption request. In some embodiments, the consuming may include destroying, using the processing device, the cryptocurrency-based loyalty token. In some embodiments, the consuming may include transferring, using the processing device, the cryptocurrency-based loyalty token to the loyalty program wallet.

At 506, the method 500 may include transmitting, using the communication device, indication of the consuming to the POS device. Further, a cost of availing one or more of the product and the service may be adjusted according to the cryptocurrency-based loyalty token.

At 508, the method 500 may include storing, using the storage device, token redemption data on the blockchain. Further, the token redemption data may include at least one characteristic associated with each of the user account, the redemption request, the consuming of the cryptocurrency-based loyalty token, one or more of the product and the service and the cost.

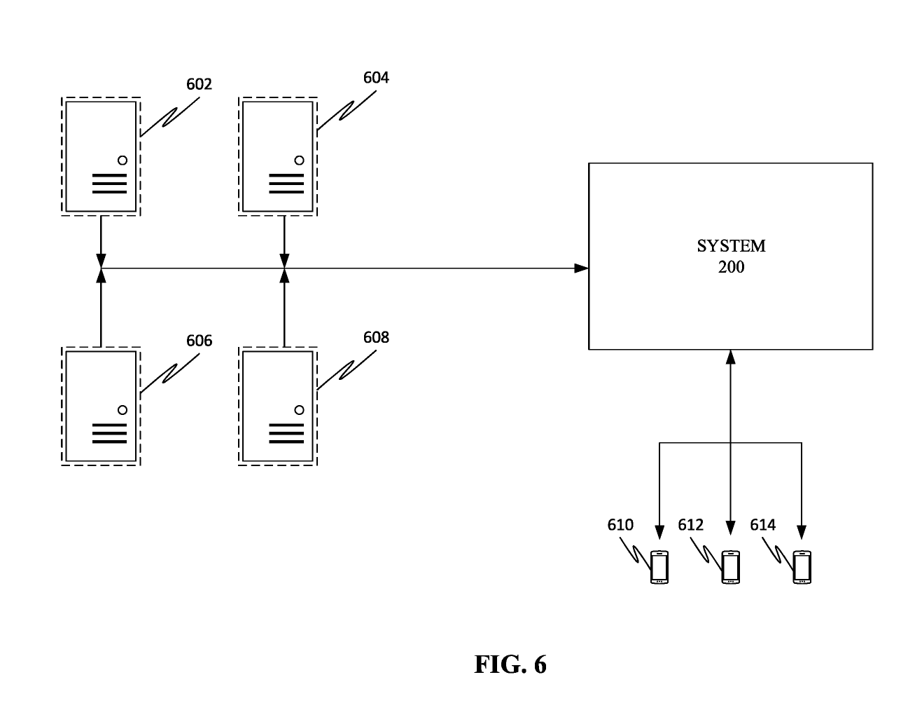

FIG. 6 is a block diagram, showing the system 200 of facilitating management of cryptocurrency-based loyalty points associated with one or more of a product and a service, in accordance with an exemplary embodiment. The system 200 may interface with user devices 612, 614, and 616, and external servers 602, 604, 606, and 608. Further, the system 200 may communicate with user devices 612, 614, and 616 such as smartphones, computer tablets, computing devices such as personal computers or laptops, and wearable devices, such as smartwatches. Further, the system 200 may communicate with external servers 602, 604, 606, and 608. The external servers may include one or more airline servers, servers maintained by one or more hotel chains, or servers maintained by other such establishments offering one or more services. Accordingly, the one or more airlines, hotel chains, or other establishments may offer loyalty points, reward points, or airline miles.

The system 200 may receive the loyalty points, reward points, or airline miles offered by the one or more airlines, hotel chains, or other establishments.

Further, the system 200 may generate one or more cryptocurrency tokens, representing the loyalty points, reward points, or airline miles offered by the one or more airlines, hotel chains, or other establishments.

Accordingly, one or more users, such as users associated with the user devices 612, 614, and 616 may be able to procure the one or more cryptocurrency tokens generated by the system 200. Further, the users associated with the user devices 612, 614, and 616 may be able to trade the one or more cryptocurrency tokens on one or more external exchanges. Further, the users associated with the user devices 612, 614, and 616 may be able to exchange the one or more cryptocurrency tokens representing the loyalty points, reward points, or airline miles offered by the one or more airlines, hotel chains, or other establishments to acquire airline tickets, make hotel reservations, or procure one or more other services.

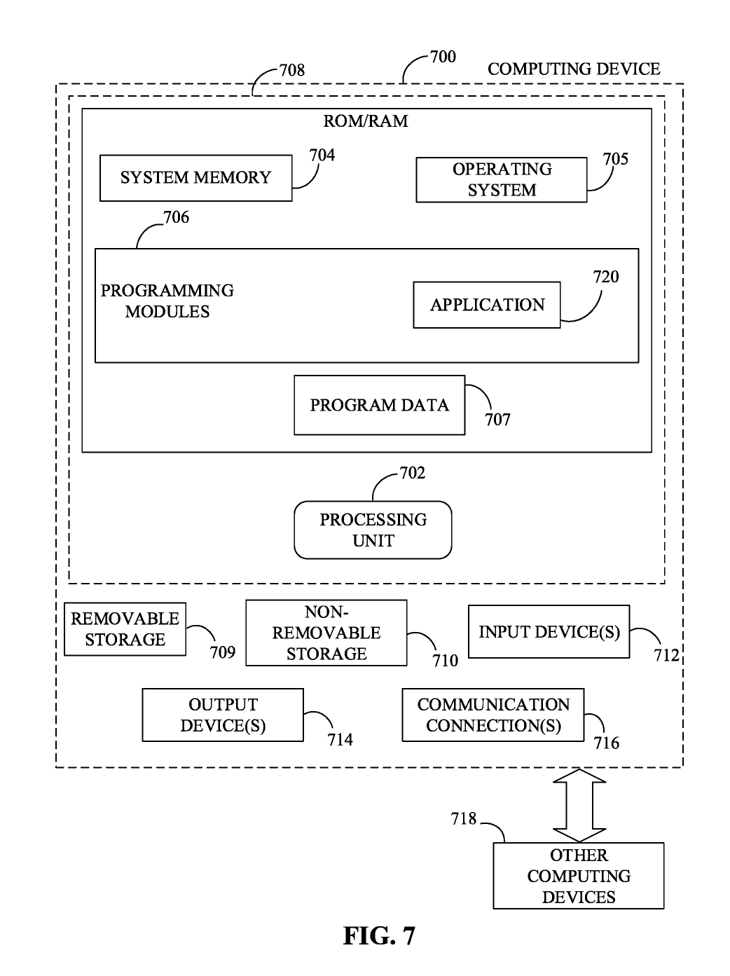

FIG. 7 is a block diagram of a computing device for implementing the methods disclosed herein, in accordance with some embodiments. Consistent with an embodiment of the disclosure, the aforementioned storage device and processing device may be implemented in a computing device, such as computing device 700 of FIG. 7. Any suitable combination of hardware, software, or firmware may be used to implement the memory storage and processing unit. For example, the storage device and the processing device may be implemented with computing device 700 or any of other computing devices 718, in combination with computing device 700. The aforementioned system, device, and processors are examples and other systems, devices, and processors may comprise the aforementioned storage device and processing device, consistent with embodiments of the disclosure.

With reference to FIG. 7, a system consistent with an embodiment of the disclosure may include a computing device or cloud service, such as computing device 700. In a basic configuration, computing device 700 may include at least one processing unit 702 and a system memory 704. Depending on the configuration and type of computing device, system memory 704 may comprise, but is not limited to, volatile (e.g. random access memory (RAM)), non-volatile (e.g. read-only memory (ROM)), flash memory, or any combination. System memory 704 may include operating system 705, one or more programming modules 706, and may include a program data 707. Operating system 705, for example, may be suitable for controlling computing device 700's operation. Furthermore, embodiments of the disclosure may be practiced in conjunction with a graphics library, other operating systems, or any other application program and is not limited to any particular application or system. This basic configuration is illustrated in FIG. 7 by those components within a dashed line 708.

Computing device 700 may have additional features or functionality. For example, computing device 700 may also include additional data storage devices (removable and/or non-removable) such as, for example, magnetic disks, optical disks, or tape. Such additional storage is illustrated in FIG. 7 by a removable storage 709 and a non-removable storage 710. Computer storage media may include volatile and nonvolatile, removable and non-removable media implemented in any method or technology for storage of information, such as computer-readable instructions, data structures, program modules, or other data. System memory 704, removable storage 709, and non-removable storage 710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 700. Any such computer storage media may be part of device 700. Computing device 700 may also have input device(s) 712 such as a keyboard, a mouse, a pen, a sound input device, a touch input device, etc. Output device(s) 714 such as a display, speakers, a printer, etc. may also be included. The aforementioned devices are examples and others may be used.

Computing device 700 may also contain a communication connection 716 that may allow device 700 to communicate with other computing devices 718, such as over a network in a distributed computing environment, for example, an intranet or the Internet. Communication connection 716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 704, including operating system 705. While executing on processing unit 702, programming modules 706 (e.g., application 720) may perform processes including, for example, one or more stages of methods 300-500, algorithms, systems, applications, servers, databases as described above. The aforementioned process is an example, and processing unit 702 may perform other processes. Other programming modules that may be used in accordance with embodiments of the present disclosure may include sound encoding/decoding applications, machine learning application, acoustic classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

What is claimed is:

1. A method of facilitating issuance and management of cryptocurrency-based loyalty points associated with at least one of a product and a service, the method comprising:
receiving, using a communication device, a purchase request for obtaining at least one cryptocurrency-based loyalty token to be associated with a user account;
transferring, using a processing device, the at least one cryptocurrency-based loyalty token to a loyalty user wallet associated with the user account based on the purchase request; and
storing, using a storage device, token allocation data on a blockchain, wherein the token allocation data comprises at least one characteristic associated with each of the user account, the purchase request, transferring of the at least one cryptocurrency-based loyalty token and the loyalty user wallet.

2. The method of claim 1, wherein the purchase request comprises indication of at least one cryptocurrency to be exchanged with the at least one cryptocurrency based loyalty token, the method further comprising transferring, using the processing device, at least one cryptocurrency from at least one cryptocurrency wallet associated with the user account to a cryptocurrency program wallet based on an exchange rate between the at least one cryptocurrency and the at least one cryptocurrency based loyalty token.

3. The method of claim 1, further comprising:
receiving, using the communication device, a creation request from a user device associated with an issuer account, wherein the creation request comprises indication of at least one of the product and the service and at least one rule;
generating, using the processing device, a plurality of cryptocurrency-based loyalty tokens based on the creation request, wherein the plurality of cryptocurrency-based loyalty tokens comprises the at least one cryptocurrency-based loyalty token; and
storing, using the storage device, token creation data comprising at least one characteristic associated with each of the issuer account, the creation request, the indication of at least one of the product and the service and the plurality of cryptocurrency-based loyalty tokens.

4. The method of claim 3, wherein the generating comprises mining the at least one cryptocurrency-based loyalty token on a cryptocurrency network.

5. The method of claim 3, wherein the generating comprises retrieving the plurality of cryptocurrency-based loyalty tokens from a loyalty program wallet.

6. The method of claim 1, further comprising:
receiving, using a communication device, a redemption request from a point of sale (POS) device, wherein the redemption request is associated with the user account;
consuming, using the processing device, a cryptocurrency-based loyalty token from the loyalty user wallet based on the redemption request;
transmitting, using the communication device, indication of the consuming to the POS device, wherein a cost of availing at least one of the product and the service is adjusted according to the cryptocurrency-based loyalty token; and
storing, using the storage device, token redemption data on the blockchain, wherein the token redemption data comprises at least one characteristic associated with each of the user account, the redemption request, the consuming of the cryptocurrency-based loyalty token, at least one of the product and the service and the cost.

7. The method of claim 6, wherein the consuming comprises destroying, using the processing device, the cryptocurrency-based loyalty token.

8. The method of claim 6, wherein the consuming comprises transferring, using the processing device, the cryptocurrency-based loyalty token to the loyalty program wallet.

9. The method of claim 1, wherein the at least one cryptocurrency-based loyalty token corresponds to a plurality of travel points, wherein the plurality of travel points may be used to avail at least one of a travel related product and a travel related service.

10. The method of claim 1, wherein the at least one cryptocurrency-based loyalty token may be traded at a cryptocurrency-based exchange.

11. A system of facilitating management of cryptocurrency-based loyalty points associated with at least one of a product and a service, the system comprising:
a communication device configured for receiving a purchase request for obtaining at least one cryptocurrency-based loyalty token to be associated with a user account;
a processing device configured for transferring the at least one cryptocurrency-based loyalty token to a loyalty user wallet associated with the user account based on the purchase request; and
a storage device configured for storing token allocation data on a blockchain, wherein the token allocation data comprises at least one characteristic associated with each of the user account, the purchase request, transferring of the at least one cryptocurrency-based loyalty token and the loyalty user wallet.

12. The system of claim 11, wherein the purchase request comprises indication of at least cryptocurrency to be exchanged with the at least one cryptocurrency based loyalty token, the method further comprising transferring, using the processing device, at least one cryptocurrency from at least one cryptocurrency wallet associated with the user account to a cryptocurrency program wallet based on an exchange rate between the at least one cryptocurrency and the at least one cryptocurrency based loyalty token.

13. The system of claim 11, wherein the communication device is further configured for receiving a creation request from a user device associated with an issuer account, wherein the creation request comprises indication of at least one of the product and the service and at least one rule, wherein the processing device is further configured for generating a plurality of cryptocurrency based loyalty tokens based on the creation request, wherein the plurality of cryptocurrency based loyalty tokens comprises the at least one cryptocurrency based loyalty token, wherein the storage device is further configured for storing token creation data comprising at least one characteristic associated with each of the issuer account, the creation request, the indication of at least one of the product and the service and the plurality of cryptocurrency-based loyalty tokens.

14. The system of claim 13, wherein the generating comprises mining the at least one cryptocurrency-based loyalty token on a cryptocurrency network.

15. The system of claim 13, wherein the generating comprises retrieving the plurality of cryptocurrency-based loyalty tokens from a loyalty program wallet.

16. The system of claim 11, wherein the communication device is further configured for:
receiving, using a communication device, a redemption request from a point of sale (POS) device, wherein the redemption request is associated with the user account; and
transmitting, using the communication device, indication of a consuming of cryptocurrency based loyalty token to the POS device, wherein a cost of availing at least one of the product and the service is adjusted according to the cryptocurrency based loyalty token, wherein the processing device is further configured for performing the consuming of the cryptocurrency based loyalty token from the loyalty user wallet based on the redemption request, wherein the storage device is further configured for storing token redemption data on the blockchain, wherein the token redemption data comprises at least one characteristic associated with each of the user account, the redemption request, the consuming of the cryptocurrency based loyalty token, at least one of the product and the service and the cost.

17. The system of claim 16, wherein the consuming comprises destroying, using the processing device, the cryptocurrency-based loyalty token.

18. The system of claim 16, wherein the consuming comprises transferring, using the processing device, the cryptocurrency-based loyalty token to the loyalty program wallet.

19. The system of claim 11, wherein the at least one cryptocurrency-based loyalty token corresponds to a plurality of travel points, wherein the plurality of travel points may be used to avail at least one of a travel related product and a travel related service.

20. The system of claim 11, wherein the at least one cryptocurrency-based loyalty token may be traded at a cryptocurrency-based exchange.
